(19) United States
(12) Patent Application Publication
(10) Pub. No.: US 2016/0275000 A1
(43) Pub. Date: Sep. 22, 2016

(54) SYSTEM AND METHOD OF AUTOMATED APPLICATION SCREEN FLOW GENERATION FOR DETECTING ABERRATION IN MOBILE APPLICATION

(71) Applicant: Wegilant Net Solutions Pvt. Ltd., Mumbai (IN)

(72) Inventor: Toshendra Sharma, Mumbai (IN)

(21) Appl. No.: 14/821,642

(22) Filed: Aug. 7, 2015

(30) Foreign Application Priority Data
Mar. 17, 2015 (IN) 887/MUM/2015

(51) Int. Cl. G06F 11/36; G06F 3/0482; G06F 3/0484

(52) U.S. Cl. CPC G06F 11/3664; G06F 3/04842; G06F 3/0482

(57) ABSTRACT

A processor implementing an application screen flow generator for identifying an aberration in a mobile application is disclosed. The application screen flow generator includes an activity status detection module that determines a processing status for a launchable visible component selected from the launchable visible components, a clickable element processing module that retrieves a set of clickable elements for the launchable visible component and determines a number of clickable elements in the launchable visible component, a node detection module that determines that the launchable visible component is a child component if launched by clicking on a previous launchable visible component or determines that the launchable visible component is a parent component if it launches a subsequent launchable visible component, and an application flow representation module that represents a flow of the launchable visible components.

### CROSS-REFERENCE TO RELATED APPLICATIONS

This application claims priority to Indian patent application no. 887/MUM/2015 filed on Mar. 17, 2015, the complete disclosure of which, in its entirely, is herein incorporated by reference.

### BACKGROUND

1. Technical Field

The embodiments herein generally relate to evaluation of mobile applications to identify aberrations, and more particularly, to a system and method for automatically generating an application screen flow of a mobile application that can be used for evaluation of the mobile application such as for testing, identifying loopholes, vulnerabilities, etc.

2. Description of the Related Art

Mobile application development has become a major industry worldwide. The industry has grown as the demand for portable phones, has increased. A highly competitive mobile application marketplace and the consumerization of information technology have put tremendous pressure on mobile application developers to deliver high quality mobile user experiences for both consumers and employees. In this competitive environment, a small defect or failure may lead to permanent application abandonment or poor reviews. Moreover, device fragmentation, with hundreds of mobile computers on the market for a variety of different mobile operating systems, multiplies quality assurance efforts resulting in a time-consuming and costly development process.

One major cost to application developers includes costs associated with staffing of sufficient programmers to provide adequate error and bug checking. Since a large number of phones and operating system versions have been released, designing an application to run on all platforms requires significant error checking. Releasing an application with errors can be disastrous for a company. In response to the needs of the developers, certain testing companies offer manual error and bug testing services for application developer companies. These testing companies hire programmers to apply series of test protocols in order to discover errors or bugs in the application and to report a bug to the developers. While the testing companies are able to reduce the staffing complexities of the application developers, such companies typically charge hourly rates for software testing, so the costs associated with error testing remain high.

Hence, there has been a shift towards automated software testing, which involves the use of special software, which is separate from the software that is being tested, to control the execution of tests and the comparison of actual outcomes with predicted outcomes. Test automation can automate some repetitive but necessary tasks in a formalized testing process already in place, or add additional testing that would be difficult to perform manually. Further, while developing mobile applications, apart from errors and bugs, security is also critical. Security loopholes in a mobile application allow hackers to steal critical data such as passwords, location data, credit card data, personal and private data etc. To effectively understand the flaws in mobile application, a person evaluating the application would require an intuitive knowledge regarding the layout and flow of the application to take decisions regarding the presence of bugs, security loopholes etc.

While attempting to replace a human tester with an automated solution, the system has to intelligently gather information regarding the flow of the application and build that human intuitive understanding for the tests to work on the application, since tests for the corresponding errors and loopholes will also have to be automated. Accordingly, there is a need for automatically generating an application screen flow of a mobile application that can be used for evaluation of the mobile application such as for testing, identifying loopholes, vulnerability analysis etc.

### SUMMARY

In view of the foregoing, an embodiment herein provides a method of generating an application screen flow for identifying an aberration in a mobile application. These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

Several methods and systems for application screen flow generator for identifying an aberration in a mobile application are disclosed. In one aspect, a processor implementing an application screen flow generator for identifying an aberration in a mobile application includes an activity processing module, an activity launch module, an activity status detection module, a clickable element processing module, a node detection module, an activity execution verification module, and an application flow representation module. The activity processing module processes a data structure of the mobile application to obtain a list of visible components. The activity launch module determines whether each of the visible components can be launched or not to obtain a list of launchable visible components. The activity status detection module determines a processing status for a launchable visible component selected from the launchable visible components and the processing status is selected from a group (i) processing not started (ii) processing started, and (iii) processing complete. The clickable element processing module retrieves a set of clickable elements for the launchable visible component and determines a number of clickable elements in the launchable visible components. The node detection module determines that the launchable visible component is a child component if it is launched by clicking on a previous launchable visible component or determines that the launchable visible component is a parent component if it launches a subsequent launchable visible component. The activity execution verification module processes the child component based on the processing status. The application flow representation module represents a flow of the launchable visible components. At least one launchable visible component is represented as a child node and at least one launchable visible component is represented as a parent node. The application screen flow generator includes an activity view module and the activity view module determines whether each of the launchable visible components includes at least one of a web view, or a text view. The application screen flow generator further includes an indicator association module and the indicator association module associates an indicator of the processing status of the launchable visible component with the processing status.

In an embodiment, the indicator association module (i) associates a first color with the launchable visible component when the processing status is the processing not started, (ii) associates a second color with the launchable visible component when the processing status is the processing started, and (iii) associates a third color with the launchable visible component when the processing status is the processing complete. The activity execution verification module processes the child component only when the processing status is the ‘processing started’. The flow of the launchable visible components is visually represented in the form of a graph that includes connections between the launchable visible components for calculating an exploitability index level of a specific launchable visible component for exploiting the mobile application.

In another aspect, an automated application screen flow generation system for detecting an aberration in a mobile application includes a memory unit and a processor. The memory unit stores a data structure and a set of modules. The processor executes the set of modules and the set of modules includes an activity processing module, an activity launch module, an activity status detection module, a clickable element processing module, a node detection module, an activity execution verification module, and an application flow representation module. The activity processing module processes a data structure of the mobile application to obtain a list of visible components. The activity launch module determines whether each of the visible components can be launched or not to obtain a list of launchable visible components. The activity view determines whether each of the launchable visible components includes at least one of a web view, or a text view. The activity status detection module determines a processing status for a launchable visible component selected from the launchable visible components and the processing status is selected from a group (i) processing not started (ii) processing started, and (iii) processing complete. The clickable element processing module retrieves a set of clickable elements for the launchable visible component and determines a number of clickable elements in the launchable visible component. The node detection determines that the launchable visible component is a child component if it is launched by clicking on a previous launchable visible component or determines that the launchable visible component is a parent component if it launches a subsequent launchable visible component. The activity execution verification module processes the child component based on the processing status. The application flow representation module represents a flow of the launchable visible components that includes connections between the launchable visible components for calculating an exploitability index level of a specific launchable visible component that includes at least one of (a) the web view, or (b) the text view for exploiting the mobile application and at least one launchable visible component is represented as a child node and at least one launchable visible component is represented as a parent node. In an embodiment, the indicator association module (i) associates a first color with the launchable visible component when the processing status is the processing not started, (ii) associates a second color with the launchable visible component when the processing status is the processing started, and (iii) associates a third color with the launchable visible component when the processing status is the processing complete and the activity execution verification module processes the child component only when the processing status is the ‘processing started’.

In yet another aspect, a processor implemented method of generating an application screen flow for a mobile application includes processing a data structure of the mobile application to obtain a list of visible components, determining whether each of the visible components can be launched or not to obtain a list of launchable visible components, determining whether each of the launchable visible components includes a web view, or a text view based on a plurality of activity views, determining a processing status for a launchable visible component selected from the launchable visible components and the processing status is selected from a group (i) processing not started (ii) processing started, and (iii) processing complete, associating a first color with the launchable visible component when the processing status is the processing not started, a second color with the launchable visible component when the processing status is the processing started, and (iii) a third color with the launchable visible component when the processing status is the processing complete, verifying an initiation for processing the launchable visible component and launching the launchable visible component upon the initiation being verified, retrieving a set of clickable elements for the launchable visible component, determining whether a click on a clickable element from the set of clickable elements changes the launchable visible component, determining whether the launchable visible component is a child component of a previous launchable visible component before the click, based on the indicator of the processing status associated with the launchable visible component if the click on the clickable element changes the launchable visible component, and generating the application screen flow that includes a representation of the launchable visible components as child components and parent components. In an embodiment, the application screen flow represents a flow of the launchable visible components that includes connections between the launchable visible components for calculating an exploitability index level of a specific launchable visible component that includes at least one of (a) the web view, or (b) the text view for exploiting the mobile application.

### BRIEF DESCRIPTION OF THE DRAWINGS

The embodiments herein will be better understood from the following detailed description with reference to the drawings, in which:

FIG. 1 illustrates a system view of an application object manager communicating with an app executable parser, an xml utility and a component factory, according to an embodiment herein;

FIG. 2 illustrates a system view of an instrumented sandbox communicating with the application object manager of FIG. 1 through an AVD Manager, a user interface automator, and an application flow graph generator according to an embodiment herein;

FIG. 3 illustrates an exploded view of the application flow graph generator of FIG. 2 according to an embodiment herein;

FIG. 4A is a process flow that illustrates an activity launch sub process executed by the application flow generator of FIG. 2 according to an embodiment herein;

FIG. 4B is a process flow that illustrates an activity view detection sub process executed by the application flow generator of FIG. 2 according to an embodiment herein;

FIG. 4C is a process flow that illustrates an activity execution verification sub process executed by the application flow generator of FIG. 2 according to an embodiment herein;

FIG. 4D is a process flow that illustrates an extracting clickable elements sub process executed by the application flow generator of FIG. 2 according to an embodiment herein;

FIG. 4E is a process flow that illustrates a node detection sub process executed by the application flow generator of FIG. 2 according to an embodiment herein;

FIG. 5 is a process flow that illustrates an implementation of the application flow generator of FIG. 2 used in conjunction with a detector exploitation sub process to identify loopholes in an application, according to an embodiment herein;

FIG. 6 is a flow diagram of an application flow generated by the application flow generator of FIG. 2, represented in a visual graph format according to an embodiment herein;

FIG. 7 is a table view of the application flow generated by the application flow generator of FIG. 2 according to an embodiment herein;

FIG. 8A-8C is a flow diagram illustrating a processor implemented method of generating an application screen flow for a mobile application according to an embodiment herein;

FIG. 9 is a flow diagram of an application flow generated by the application flow generator of FIG. 2, represented in a visual graph format according to an embodiment herein;

FIG. 10 is a flow diagram of an application flow generated by the application flow generator of FIG. 2, represented in a visual graph format according to an embodiment herein; and

FIG. 11 is a schematic diagram of a computer architecture used in accordance to the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein. As mentioned there remains a need for automatically generating an application screen flow of a mobile application that can be used for evaluation of the mobile application such as for testing, identifying loopholes, vulnerability analysis etc. Embodiments herein disclose generating an application flow graph that is compatible with automated software testing and automated security analysis.

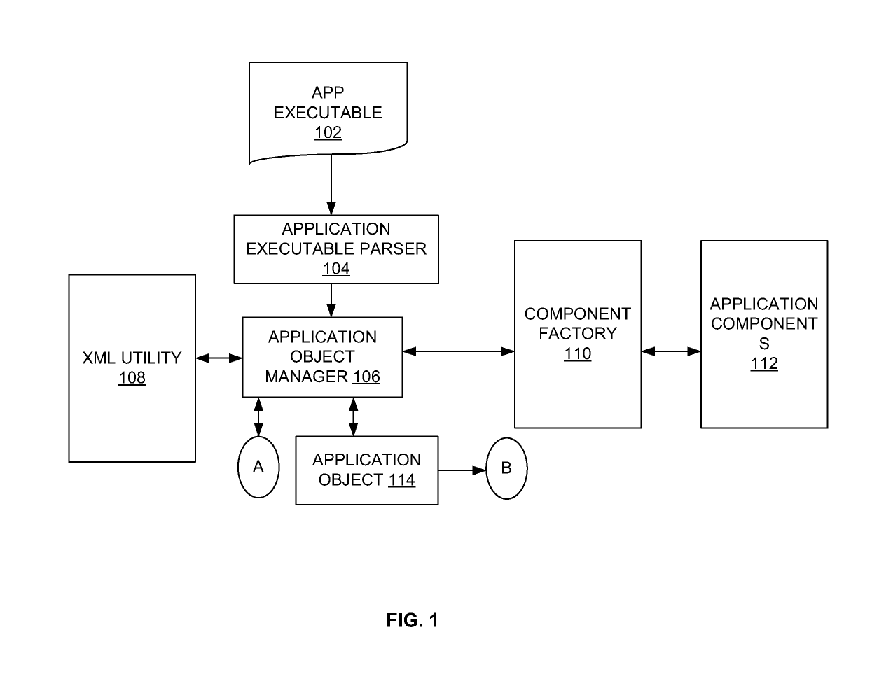

FIG. 1 illustrates a system view 100 of an application object manager 106 communicating with an app executable parser 104, a xml utility 108 and a component factory 110 according to an embodiment herein. The system includes an executable application file 102 and an application component 112. The executable application 102 is taken as an input by a device and installed on the device to be used as a usable application on it. In one embodiment, the executable application file 102 is an apk file of an android application object 114. The executable application file 102 is given as input to the application executable parser 104, which explodes the executable file and extracts an application xml file, which is also known as a manifest xml file.

An xml representation of the executable application file is given as an input to the application object manager 106 and is responsible for building an entity that represent the entire application in the form of an in memory entity. An Application xml file given as an input to the xml utility 108 that parses the xml file and returns an in memory data structure representing the contents of the file. A component name is provided as an input to a component factory 110. The component factory 110 is a utility which analyses and returns the in memory entity of a component based on the input from the application object manager 106 to obtain the necessary object from the application component 112.

The application component 112 is an in memory store of the various components that are present in the framework and are used by the application as a whole. Application object details are sent to an application object 114. A map represents the contents of the application xml file as element names to a node list of a respective element. A request is made to get an in memory representation of component details. A response in the form of a component object is based on component details.

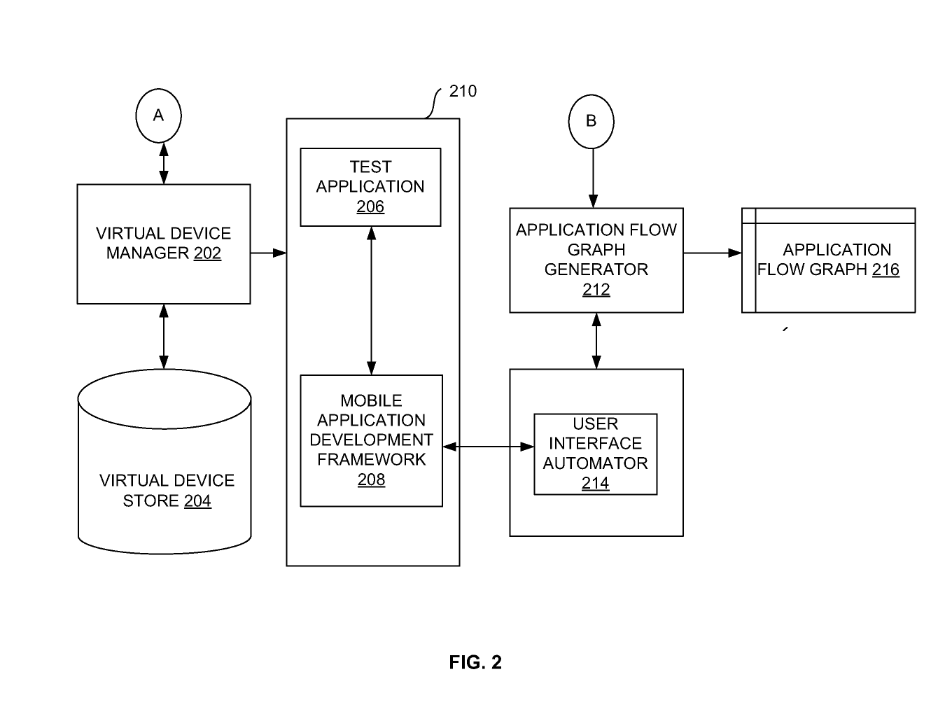

FIG. 2 illustrates a system view of an instrumented sandbox communicating with the application object manager of FIG. 1, a user interface automator 214, and an application flow graph generator 212 according to an embodiment herein. In an embodiment, the system further includes a virtual device manager 202, a virtual device store 204, an instrumented sandbox 210, and an application flow graph 212, according. A required device details based on an application's xml specifications is provided as input to the virtual device manager 202. The virtual device manager 202 is responsible for launching a required device. The virtual device store 204 is used to store virtual device images for various software development kit [SDK] versions. A request is made for launching an Instrumented sandbox environment 210. The Instrumented sandbox environment 210 represents a virtual environment in which the application is installed for real time analysis and to exploit for assessment of vulnerabilities. A request to the virtual device manager 202 is made based on a specification in an application xml file. A virtual device status is returned to the application object manager 106.

A virtual device details are provided to the virtual device manager 202 based on the request. The Instrumented sandbox environment 210 may contain a test application which is installed on an emulator. A server side script (e.g., bootstrap) is used to perform user operations on the test application. An interaction with the test application is based on instructions received from a user interface automator 214. The user interface automator 214 is a testing framework to automate a user interface testing process. A response of the operation performed on the test application contains information as to whether an operation was successful or not. An in memory application entity describes in detail the various components of the applications in an application object based on the component details provided. An application object is provided as an input to an application flow graph generator 212. An instruction may be provided to the user interface automator 214 to get the test application details or to perform any operations on the test application. An application flow graph generated by the application flow graph generator 212 as a final output may be in the form of xml, a visual graph or a table.

An Appium server may handle requests from the application flow graph generator 212 and process requests with the help of the user interface automator 214. The appium server may interact with an emulator and perform operations on the test application using the server side script. A request is provided to the server side script for interaction with the test application. The request can be for getting details of the test application or to perform user actions. A response to application flow graph generator 212 may be based on operations performed on the test application.

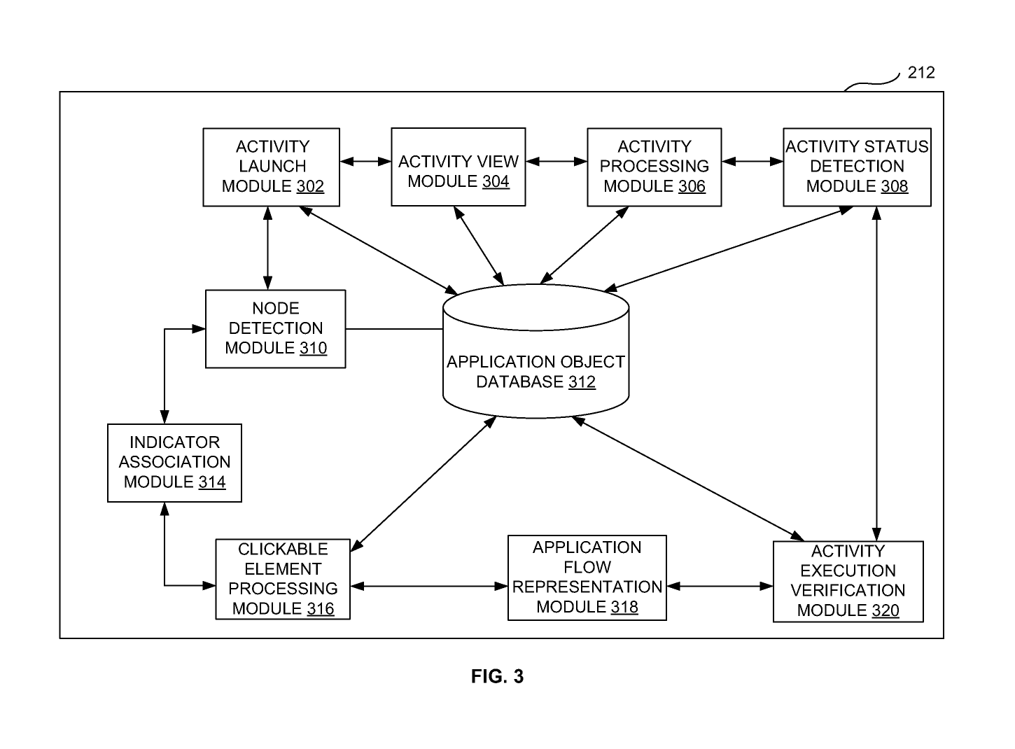

FIG. 3 illustrates an exploded view of the application flow graph generator 212 of FIG. 2 according to an embodiment herein. The application flow graph generator 212 includes an activity launch module 302, an activity view module 304, an activity processing module 306, an activity status detection module 308, a node detection module 310, an application object database 312, an indicator association module 314, a clickable elements extraction module 316, an application representation module 318, and an activity execution verification module 320, according to an embodiment herein. The activity launch module 302 launches an activity from list of visible components. The activity view module 304 determines whether a launchable visible component has a web view, or a text view for exploiting the mobile application. The activity processing module 306 processes a data structure of the mobile application to obtain a list of visible components. The activity status detection module 308 checks a processing status for a launchable visible component selected from the launchable visible components and the processing status may be processing not started, processing started, and processing complete. The activity execution verification module 320 verifies whether the processing of a visible component is initiated or not and executes the launchable visible components upon initiation. The clickable elements extraction module 316 retrieves a clickable element from a set of clickable elements and checks whether the launchable visible components has changed on click. The node recognition module 310 determines whether the launched visible component is a child node or a parent node. The activity launch module 302, the activity view module 304, the activity processing module 306 and activity status detection module 308 interacts with each other and with Application object database 312. The clickable elements extraction module 316 retrieves the clickable elements from the application object database 312 and communicates with the node detection module 310.

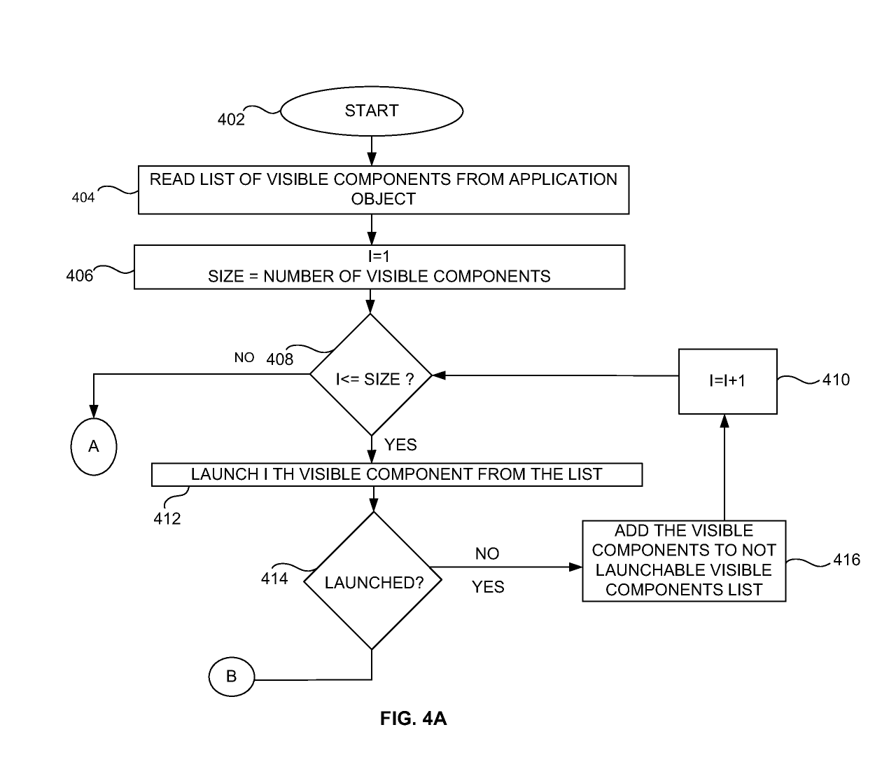

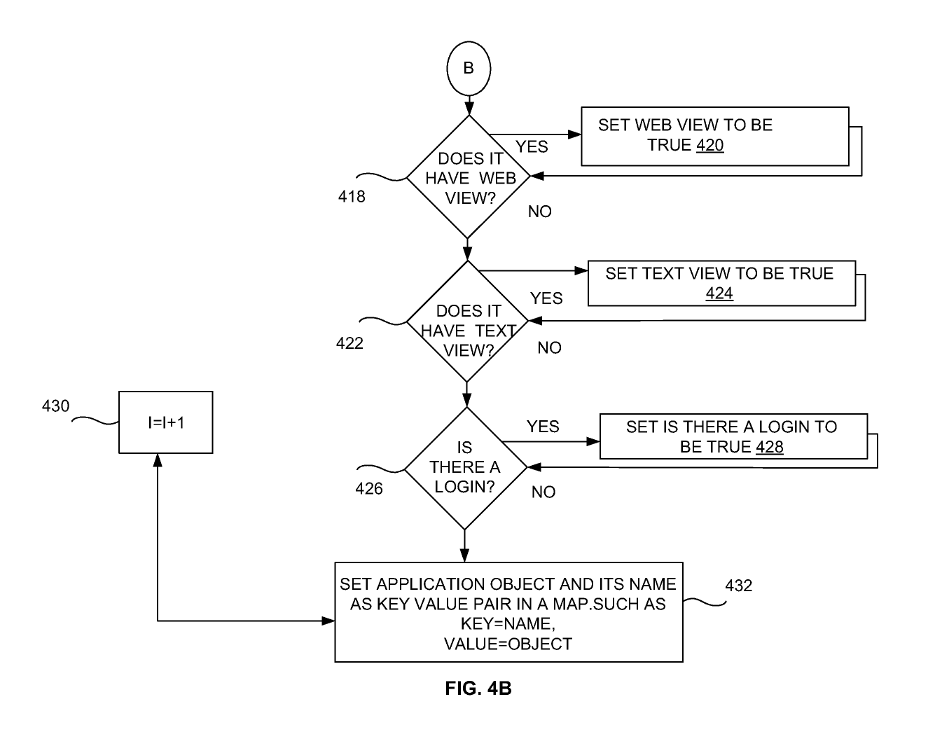

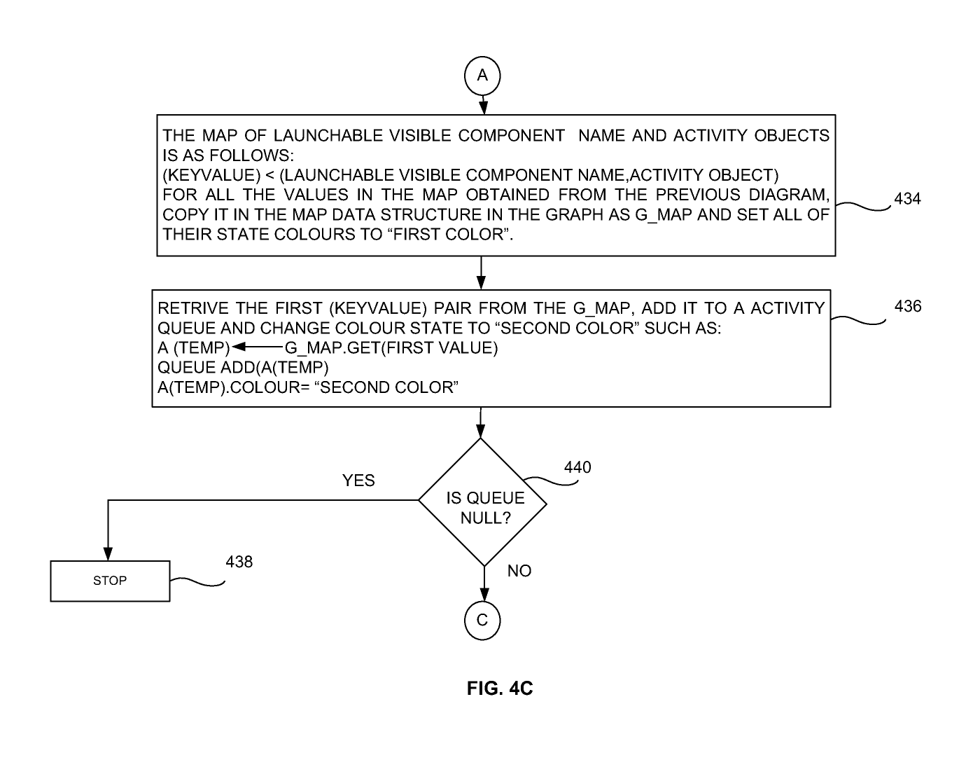

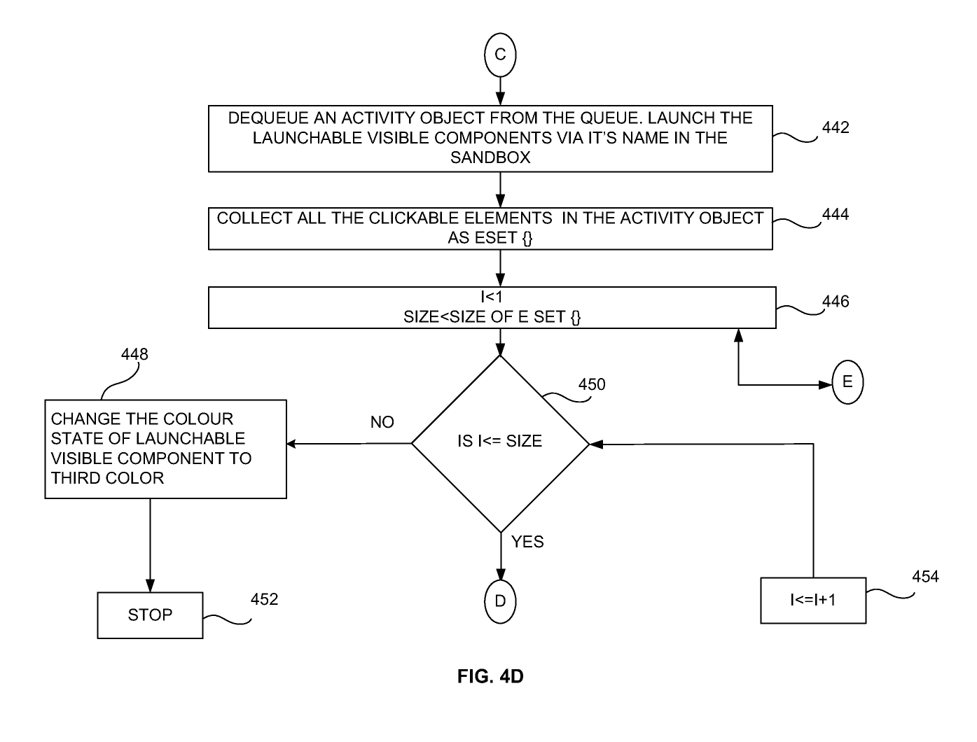

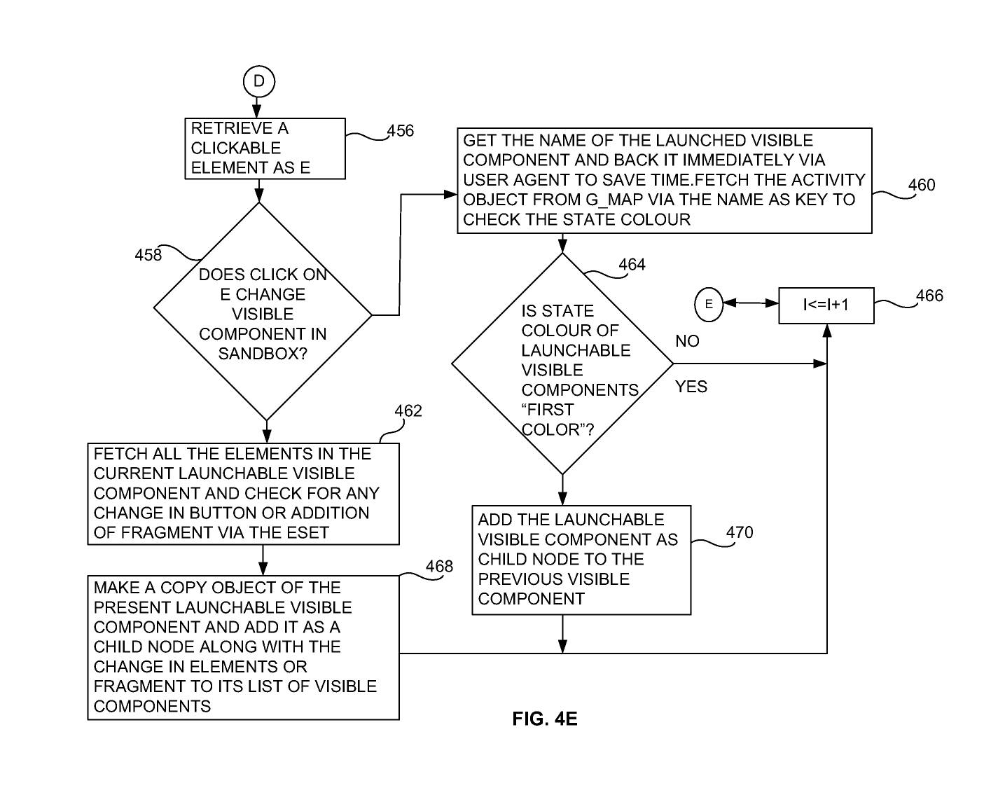

FIG. 4A is a process flow that illustrates a launch of an application sub process of the application flow generator 212 according to an embodiment herein. In an embodiment, At Step, 402, start of a flow graph generation algorithm is represented. At Step 404, a list of visible components from the application object is read. Application object is a data structure which contains application details like package name, permissions used, component details etc. At Step 403 an index variable to iterate all activities are initiated and it Stores number of activities as size. Activities are launchable visible components of the application. At Step, 404, a loop to iterate all launchable visible components is exited by an exit condition, if the index variable is greater than size (number of activities). At Step, 412, an ith launchable visible component is launched from a list of visible components, to launch the launchable visible component by making an intent call with given launchable visible components description. At Step, 408, the launchable visible components can be launched via intent filter or not is determined by a condition. At Step, 414, the launchable visible component is not launched successfully then at Step, 416, list of the non launchable visible components are added.

FIG. 4B is a process flow that illustrates an activity view detection sub process executed by the application flow generator of FIG. 2 according to an embodiment herein. At Step, 411, a web view of a launchable visible component is determined. The web view is a mobile element which represents web elements within the launchable visible components. At step, 420, the launchable visible component has a web view, and web view flag is set as true. At step, 422, a text view (text field) of a launchable visible component is determined. At step, 424, the launchable visible component has the text view and a text view flag is set as true. At step, 426 a login launchable visible component of the launchable visible components is determined. Login launchable visible components is verified whether the launchable visible components contains username, password field and login button. At step, 428, the launchable visible component is the login launchable visible component and a login flag is set as true and the above launchable visible components details are added in the application object that contains a map of launchable visible component names and launchable visible components. Activity object contains information whether it has web view, text field and etc. At step, 430, a loop index variable is incremented and a loop index variable value is determined. If the loop index variable is less than the number of launchable visible components it directs to step 404 else directs to step 434.

FIG. 4C is a process flow that illustrates an activity execution verification sub process executed by the application flow generator of FIG. 2 according to an embodiment herein. At step, 434, the application object has the map of launchable visible component names, activity objects. The launchable visible components are marked as first color to differentiate visible components states the processing is not started. To differentiate a launchable visible components three activity state colors are used. A first colour is used when processing is not started for the launchable visible components. A second colour is used when processing is started for the launchable visible components and a third colour is used when the launchable visible component has processing has been completed for the launchable visible components. In Step, 436, the first (key, value) pair is retrieved from the Graph (G_Map) and adds it to a launchable visible components queue and changes the colour state to ‘second colour’. At Step, 440, checks whether the processing queue is empty. At step, 438, the processing queue is empty and flow graph generation is stopped.

FIG. 4D is a process flow that illustrates an extracting clickable elements sub process executed by the application flow generator of FIG. 2 according to an embodiment herein. At step, 442, the processing queue is not empty and the activity object is dequeued from the processing queue and the launchable visible component is launched via the visible component name and the intent filter as required. At step, 444, all the clickable elements are retrieved in the activity object as ESet { }, here ESet is a set of clickable elements. At step, 446, the loop index variable is initialized to 1 and size is set to number of clickable elements in set. At Step, 450, I<=size is determined. At step, 448, the colour state of the launchable visible component is changed to third colour if I>=size. At step, 452, the application flow graph generation is stopped.

FIG. 4E is a process flow that illustrates a node detection sub process executed by the application flow generator of FIG. 2 according to an embodiment herein. At step, 456, the clickable elements are retrieved as E. At step, 458 the launchable visible component change is determined on click. At step, 460, the clickable elements are changed and another launchable visible component is launched, and the state of the colour of the launchable visible component is determined. At step, 464, the colour of the launchable visible component is determined whether it is first colour or not. At step, 462, the launchable visible components are not changed and the number of mobile elements that are changed on click are determined. At step, 468 a copy is made of the object of the present launchable visible component. At Step, 470, the colour of the launchable visible component is first color and the launchable visible component is added as a child node to the launchable visible component before click event. At step, 468, the child node is added along with the change in elements or fragments to its list of launchable visible component. The child node increments the loop index variable by 1 as the index variable is less than size of clickable elements set. At step, 466, the index variable is greater than size of clickable elements set or have iterated all clickable elements.

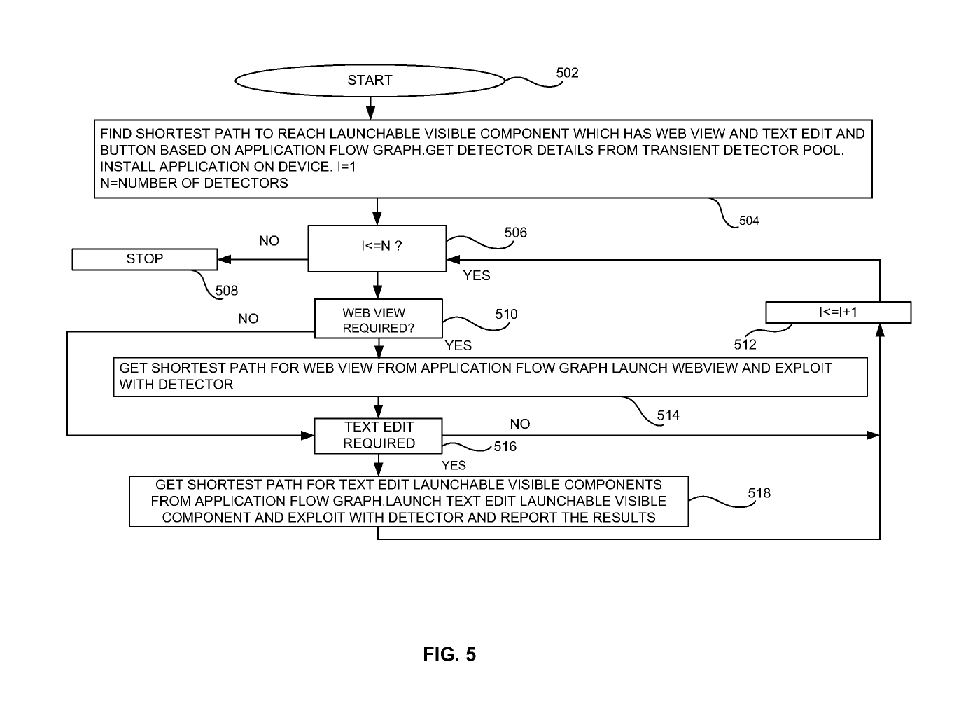

FIG. 5 is a process flow that illustrates an implementation of the application flow generator of FIG. 2 used in conjunction with a detector exploitation sub process to identify loopholes in an application, according to an embodiment herein. At step, 502, an algorithm is started. At step, 504, a detector details from a transient detector pool are taken. The detector details contain information that is the necessary conditions to find the shortest path to required visible component using application flow graph 212. At step, 506, the loop index variable is initialized to 1 and sets n to number of detectors. At step, 512, all detectors are covered under a loop detection condition. At step, 510, the web view for an ith detector is determined. At step, 514, the web view is displayed if the ith detector requires it and gets shortest path for the web view from the application flow graph 212 and exploits with the detector. At Step, 516, a text field is displayed if ith detector requires it. At step, 518 the text field is required by detector to get shortest path for a text edit visible component from the application flow graph 212 and launches the visible component with text field and exploits with detector. At Step, 512, the index variable is incremented by 1. If index variable value is greater than number of detectors then the step 506 exits the loop.

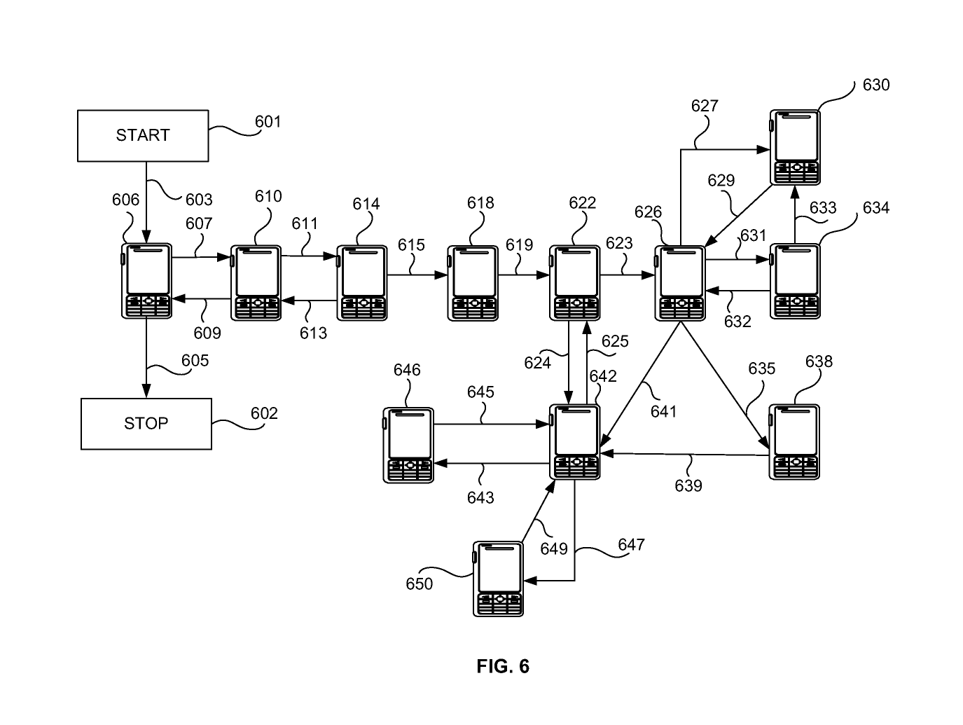

FIG. 6 is a flow diagram of an application flow generated by the application flow generator of FIG. 2, represented in a visual graph format according to an embodiment herein. In an embodiment, 601 represents start of the application. 602 represents stop application. 606 represents screen 1. 610 represents screen 2. 614 represents screen 3. 618 represents screen 4. 622 represents screen 5. 626 represents screen 6. 630 represents screen 7. 634 represents screen 8. 638 represents screen 9. 642 represents screen 10. 646 represents screen 11, and 650 represents screen 12. 603 will start application 601 and displays on 601. 607 represents clicking on Agree button will display 610. 609 represents clicking on back button will display 606. 611 represents clicking on next button will display 614. 613 represents clicking on back button will display 610. 615 represents clicking on next button will display 618. 619 represents after completing licensing process it is automatically redirected to 622. 623 represents clicking on scan apps button will display 626. 627 represents clicking on scan all apps button will display 630. 629 represents clicking on cancel scan button will display 630. 631 represents clicking on scan selected apps button will display 634. 633 represents clicking on scan now button will display 630. 632 represents clicking on cancel button will display 626. 635 represents clicking on schedule a scan button will display 638. 639 represents clicking on settings button will display 642. 641 represents clicking on settings button will display 642. 624 represents clicking on settings button will display 642. 643 represents clicking on general settings button will display 646. 645 represents clicking on back button will display 642. 647 represents clicking on scan settings button will display 650. 649 represents clicking on back button will display 642. 625 represents clicking on back button will display 622. 605 represents clicking on i disagree button will display stop application 602.

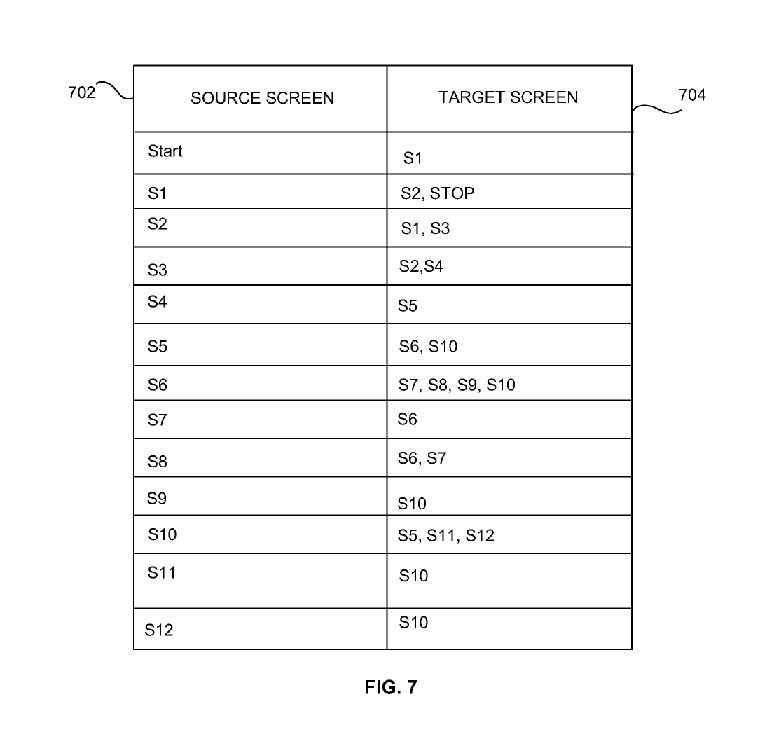

FIG. 7 is a table view of the application flow generated by the application flow generator 260 of FIG. 2 according to an embodiment herein. For a source screen 702 is start, and the target screen 704 is S1. For a source screen S1, the target screens are S2 and stop. For a source screen S3, the target screens are S2 and S4. For a source screen S4, the target screen is S5. For a source screen S5, the target screens are S6 and S10. For a source screen S6 the target screens are S7, S8, S9, and S10. For a source screen S7, the target screen is S6. For a source screen S8, the target screens are S6 and S7. For a source screen S9, the target screen is S10. For a source screen S10, the target screens are S5, S11 and S12. For a source screen S11, the target screen is S10. For a source screen S12, the target screen is S10.

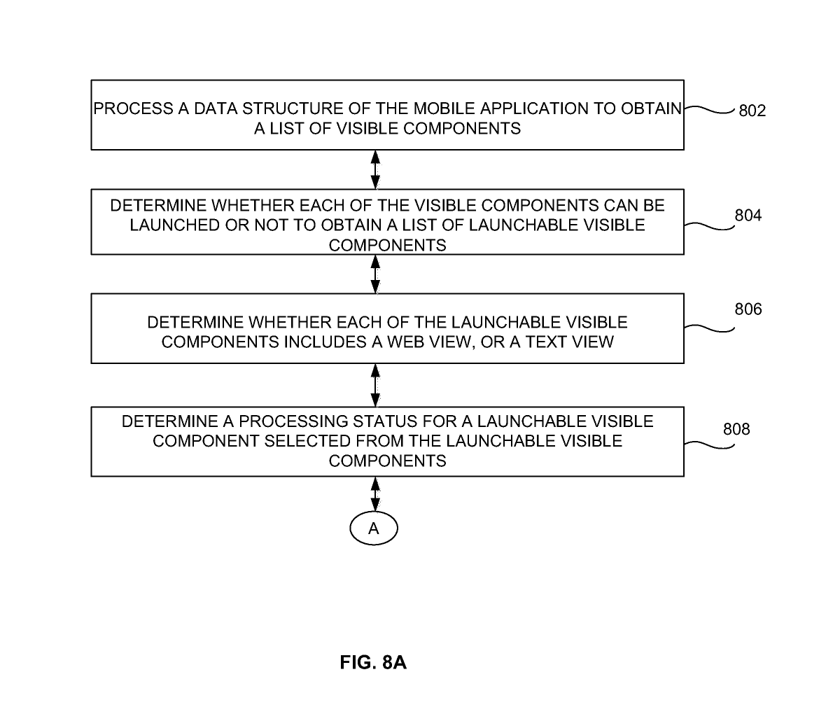

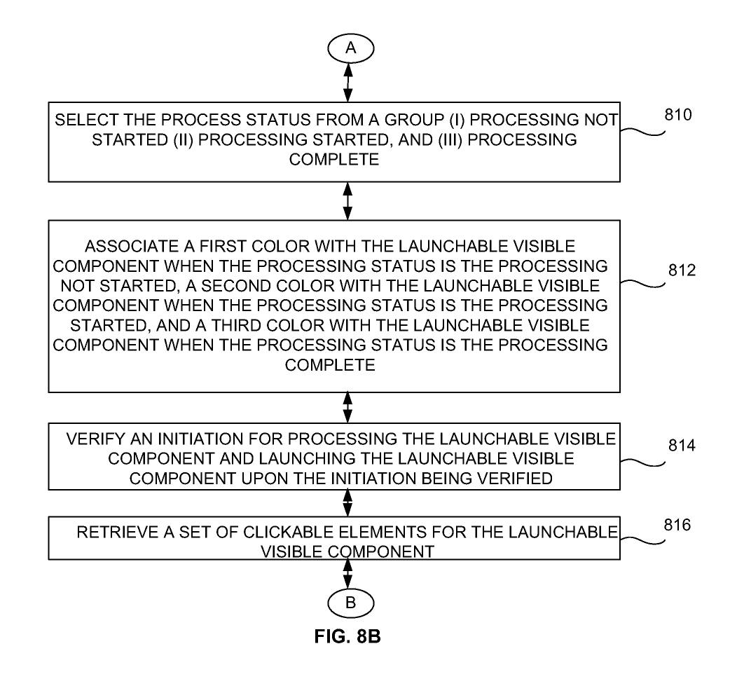

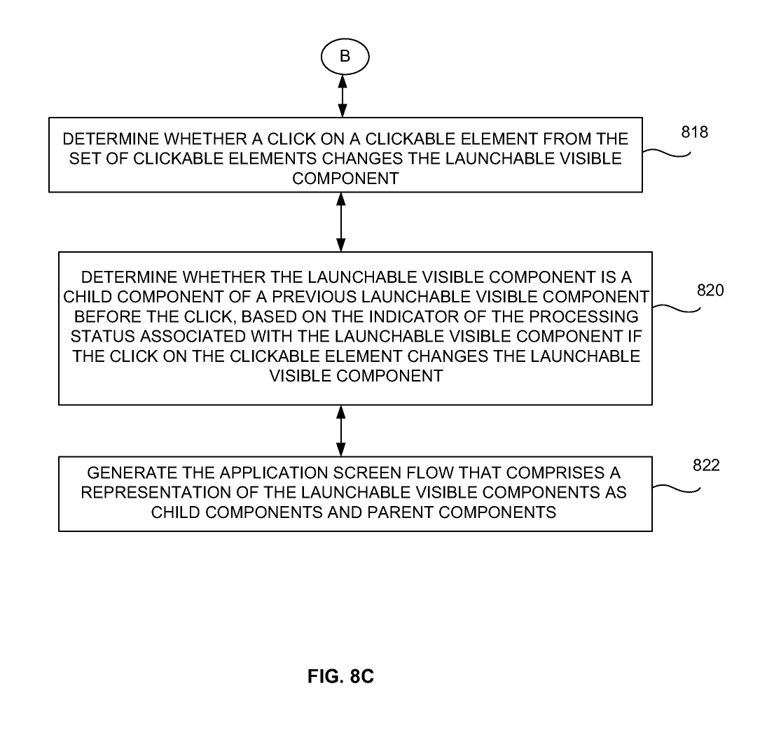

FIG. 8A-8C is a flow diagram illustrating a processor implemented method of generating an application screen flow for a mobile application according to an embodiment herein. In an embodiment, at step, 802, a list of visible components is obtained by processing a data structure of the mobile application (in for example the activity processing module 306. At step, 804, a list of launchable visible components are obtained by determining whether each of the visible components can be launched or not (through for example the activity launch module 302). At step 806, determine whether each of the launchable visible components includes a web view, or a text view based on a plurality of activity views (in for example the activity view module 304). At step, 808 and 810, determine a processing status for a launchable visible component selected from the launchable visible components and the processing status is selected from a group (i) processing not started (ii) processing in started, and (iii) processing complete (in for example the activity status detection module 308). At step, 812, associate a first color with the launchable visible component when the processing status is the processing not started, a second color with the launchable visible component when the processing status is the processing started, and a third color with the launchable visible component when the processing status is the processing complete (through for example the indicator association module 314). At step, 814, verify an initiation for processing the launchable visible component and launching the launchable visible component upon the initiation being verified (through for example the activity execution verification module 320). At step, 816, retrieve a set of clickable elements for the launchable visible component (through for example the clickable element processing module 316). At step, 818, determine whether a click on a clickable element from the set of clickable elements changes the launchable visible component (in for example clickable element processing module 316). At step, 820, determine whether the launchable visible component is a child component of a previous launchable visible component before the click, based on the indicator of the processing status associated with the launchable visible component if the click on the clickable element changes the launchable visible component (through for example the node detection module 310). At step, 822, generate the application screen flow that includes a representation of the launchable visible components as child components and parent components (in for example the application flow representation module 318).

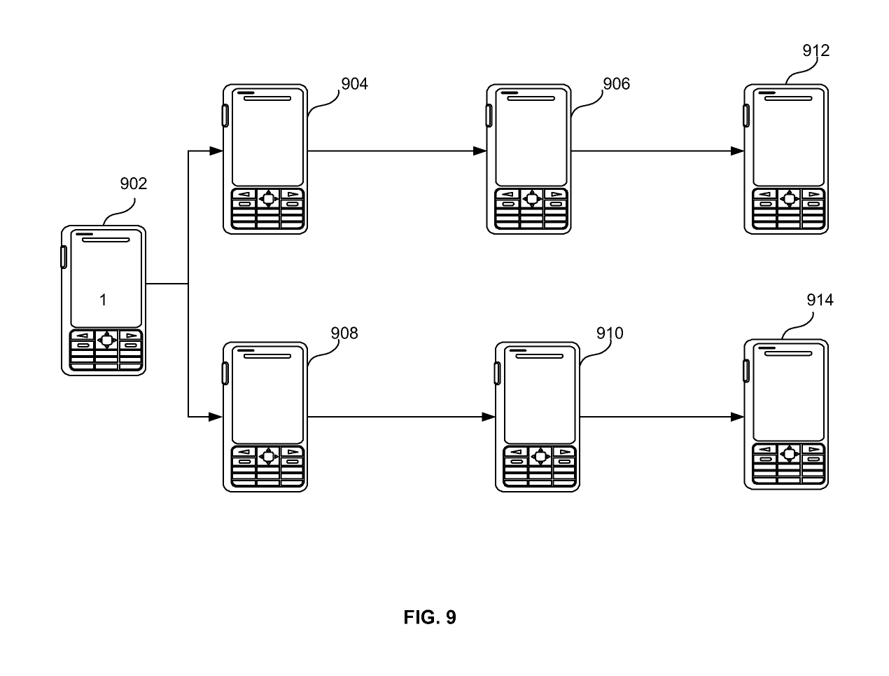

FIG. 9 is a flow diagram of an application flow generated by the application flow generator of FIG. 2, represented in a visual graph format according to an embodiment herein. In an embodiment, 902 represents screen 1, 904 represents screen 2, 906 represents screen 3, 908 represents screen 4, 910 represents screen 5, 912 represents screen 6, and 914 represents screen 7. In embodiment, a launchable visible component displayed on screen 6 is reached from screen 5. For example if an application which drives its revenue from ads, then it is important to not to launch a launchable visible component that displays ‘ads’ right from the login screen. Considering the user experience the shortest path for launchable visible component displayed on screen 6 should be reached from screen 4 and not from screen 5.

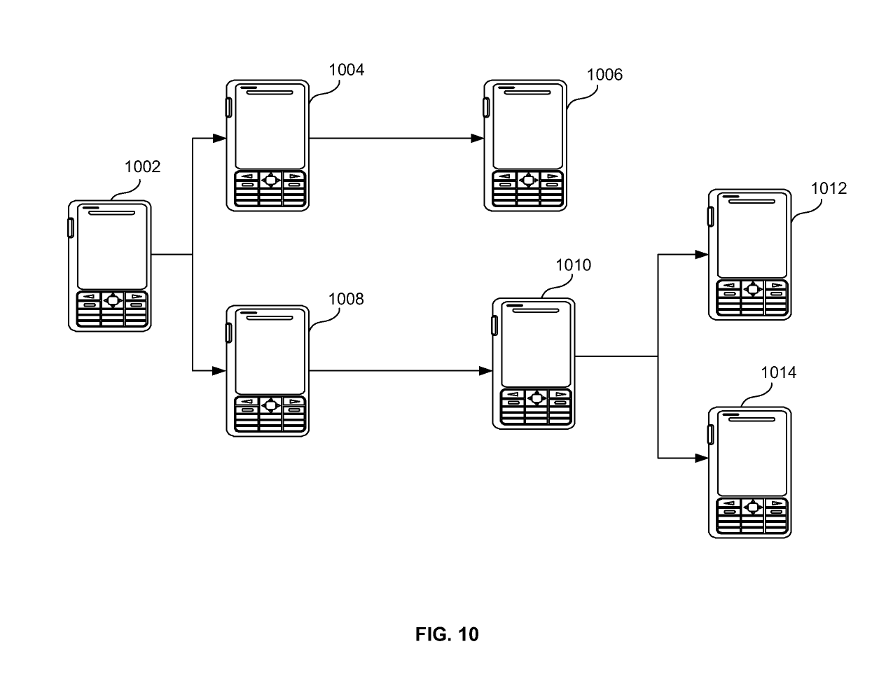

FIG. 10 is a flow diagram of an application flow generated by the application flow generator of FIG. 2, represented in a visual graph format according to an embodiment herein. In an embodiment, 1002 represents screen 1, 1004 represents screen 2, 1006 represents screen 3, 1008 represents screen 4 (text view), 1010 represents screen 5 (text view), 1012 represents screen 6, and 1014 represents screen 7. In an embodiment, an exploitable activity includes for example, a launchable visible component. In an embodiment, the launchable visible component includes a textview. As used herein the term “textview” refers to a portion of the screen where a user enters the username, password and the like. In an exemplary scenario, an attacker may enter malicious input such as XSS String or SQLinjection query in the textview to compromise a service accessed by a mobile application. In an embodiment, an exploitability index level 1 (EIL1) is a ratio of exploitable paths to the total number of paths and the exploitable path is a path with at least one exploitable activity. For example, consider three possible paths [1,2,4], [1,3,5,6], [1,3,5,7]. If ‘5’ contains a text view and the possible paths are [1, 3, 5, 6] and [1, 3, 5, 7], then the exploitability Index Level 1 (EIL1) (2/3)=0.6. Both ‘3’ and ‘5’ have textviews and the paths [1, 3, 5, 6], [1, 3, 5, 7] are exploitable paths making our EIL1=0.6 again. An application with least EIL1 is considered the most secure until an EIL2 is calculated, such that EIL2 is an exploitability index level 2 (EIL 2) and is a ratio of exploitable paths to the total number of paths and the exploitable path is a path with at least one exploitable activity.

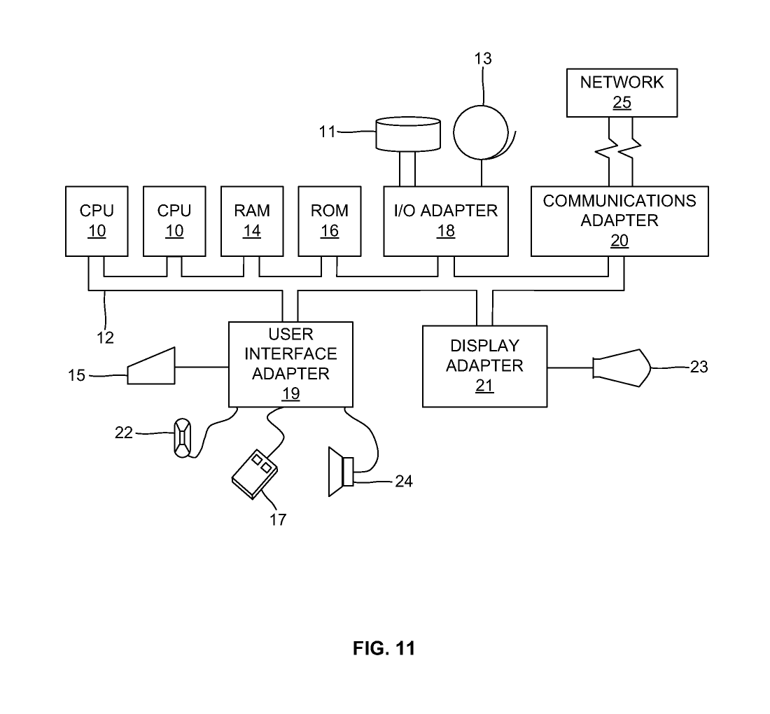

FIG. 11 is a schematic diagram of a computer architecture used in accordance to the embodiments herein. The system includes at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The activities in a flow graph can be utilized to perform different type of testing. For functional testing flow graph can be designed to test scenarios without actually opening the application, for example writing test steps for login scenario to find shortest path to reach to a login activity. For performance and stress testing this flow graph can be used with an automation tool which can calculate response time on click operations. For example to test response time for login an user can navigate to the login activity using the flow graph, by entering username, password and by clicking on login using the automation tool to get the activity change time using the automation tool. User can run this scenario multiple times programmatically to perform stress testing.

The description of the specific embodiments herein so fully reveals the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

I/We claim:

1. A processor implementing an application screen flow generator for identifying an aberration in a mobile application, said application screen flow generator comprising:
(a) an activity processing module implemented by said processor that processes a data structure of said mobile application to obtain a list of visible components;
(b) an activity launch module implemented by said processor that determines whether each of said visible components can be launched or not to obtain a list of launchable visible components;
(c) an activity status detection module implemented by said processor that determines a processing status for a launchable visible component selected from said launchable visible components, wherein said processing status is selected from a group comprising (i) processing not started (ii) processing started, and (iii) processing complete;
(d) a clickable element processing module implemented by said processor that that retrieves a set of clickable elements for said launchable visible component and determines a number of clickable elements in said launchable visible component;
(e) a node detection module implemented by said processor that determines that said launchable visible component is a child component if it is launched by clicking on a previous launchable visible component or determines that said launchable visible component is a parent component if it launches a subsequent launchable visible component;
(f) an activity execution verification module implemented by said processor that processes said child component based on said processing status; and
(g) an application flow representation module implemented by said processor that represents a flow of said launchable visible components, wherein at least one launchable visible component is represented as a child node and at least one launchable visible component is represented as a parent node.

2. The application screen flow generator of claim 1, wherein said application screen flow generator comprises an activity view module implemented by said processor that determines whether each of said launchable visible components comprises at least one of a web view, or a text view.

3. The application screen flow generator of claim 1, wherein said application screen flow generator comprises an indicator association module implemented by said processor that associates a indicator of said processing status of said launchable visible component with said processing status.

4. The application screen flow generator of claim 3, wherein said indicator association module implemented by said processor (i) associates a first color with said launchable visible component when said processing status is said processing not started, (ii) associates a second color with said launchable visible component when said processing status is said processing started, and (iii) associates a third color with said launchable visible component when said processing status is said processing complete.

5. The application screen flow generator of claim 3, wherein said activity execution verification module implemented by said processor processes said child component only when said processing status is said ‘processing started’.

6. The application screen flow generator of claim 2, wherein said flow of said launchable visible components is visually represented in the form of a graph that includes connections between said launchable visible components for calculating an exploitability index level of a specific launchable visible component for exploiting said mobile application.

7. An automated application screen flow generation system for detecting an aberration in a mobile application, comprising:
a memory unit that stores a data structure and a set of modules; and
a processor that executes the set of modules, wherein the set of modules comprise:
(a) an activity processing module implemented by said processor that processes a data structure of said mobile application to obtain a list of visible components;
(b) an activity launch module implemented by said processor that determines whether each of said visible components can be launched or not to obtain a list of launchable visible components;
(c) an activity view module implemented by said processor that determines whether each of said launchable visible components comprises at least one of a web view, or a text view;
(d) an activity status detection module implemented by said processor that determines a processing status for a launchable visible component selected from said launchable visible components, wherein said processing status is selected from a group comprising (i) processing not started (ii) processing started, and (iii) processing complete;
(e) a clickable element processing module implemented by said processor that retrieves a set of clickable elements for said launchable visible component and determines a number of clickable elements in said launchable visible component;
(f) a node detection module implemented by said processor that determines that said launchable visible component is a child component if it is launched by clicking on a previous launchable visible component or determines that said launchable visible component is a parent component if it launches a subsequent launchable visible component;
(g) an activity execution verification module implemented by said processor that processes said child component based on said processing status; and
(h) an application flow representation module implemented by said processor that represents a flow of said launchable visible components that includes connections between said launchable visible components for calculating an exploitability index level of a specific launchable visible component that comprises at least one of (a) said web view, or (b) said text view for exploiting said mobile application.

8. The automated application screen flow generation system of claim 1, wherein said indicator association module implemented by said processor (i) associates a first color with said launchable visible component when said processing status is said processing not started, (ii) associates a second color with said launchable visible component when said processing status is said processing started, and (iii) associates a third color with said launchable visible component when said processing status is said processing complete, wherein said activity execution verification module implemented by said processor processes said child component only when said processing status is said ‘processing started’.

9. A processor implemented method of generating an application screen flow for a mobile application, said method comprising steps of:
(a) processing a data structure of said mobile application to obtain a list of visible components;
(b) determining whether each of said visible components can be launched or not to obtain a list of launchable visible components;
(c) determining whether each of said launchable visible components comprises at least one of: (i) a web view, or (ii) a text view;
(d) determining a processing status for a launchable visible component selected from said launchable visible components, wherein said processing status is selected from a group comprising (i) processing not started (ii) processing started, and (iii) processing complete;
(e) associating a first color with said launchable visible component when said processing status is said processing not started, a second color with said launchable visible component when said processing status is said processing started, and (iii) a third color with said launchable visible component when said processing status is said processing complete;
(f) retrieving a set of clickable elements for said launchable visible component;
(g) determining whether a click on a clickable element from said set of clickable elements changes said launchable visible component;
(h) determining whether said launchable visible component is a child component of a previous launchable visible component before said click, based on said indicator of said processing status associated with said launchable visible component if said click on said clickable element changes said launchable visible component; and
(i) generating said application screen flow that comprises a representation of said launchable visible components as child components and parent components.

10. The processor implemented method of claim 9, wherein said application screen flow represents a flow of said launchable visible components that includes connections between said launchable visible components for calculating an exploitability index level of a specific launchable visible component that comprises at least one of (a) said web view, or (b) said text view for exploiting said mobile application.
